(19) United States
(12) Patent Application Publication
(10) Pub. No.: US 2026/0164365 A1
(43) Pub. Date: Jun. 11, 2026

(54) APPARATUS, METHOD AND COMPUTER PROGRAM

(71) Applicant: Nokia Technologies Oy, Espoo (FI)

(72) Inventors: Matha DEGHEL, Massy (FR); Sajad MEHRIZI RAHMAT ABADI, Wroclaw (PL); Majed SAAD, Massy (FR); Sanket SIT, Bangalore (IN)

(21) Appl. No.: 19/400,557

(22) Filed: Nov. 25, 2025

(30) Foreign Application Priority Data
Dec. 11, 2024 (IN) 202441097840

(51) Int. Cl. H04W 52/24; H04L 5/00

(52) U.S. Cl. CPC H04W 52/242; H04L 5/0051

(57) ABSTRACT

There is provided an apparatus comprising means for obtaining at least one predicted pathloss, wherein the pathloss corresponds to at least one target pathloss reference signal, determining whether the at least one target pathloss reference signal is maintained based on at least one first condition, wherein the at least one first condition is associated with the at least one predicted pathloss and based on the determining whether the at least one target pathloss reference signal is maintained, determining a switching delay value.

### RELATED APPLICATION

This application claims priority to, and the benefit of, Indian Application No. 202441097840, filed on Dec. 11, 2024, the contents of which is incorporated herein by reference in its entirety.

### TECHNICAL FIELD

Various embodiments of this disclosure relate generally to methods, apparatus and computer programs, and in particular, but not exclusively, to requirements and applicability conditions for reference signals.

### BACKGROUND

A communication system can be seen as a facility that enables communication sessions between two or more communication devices, or provides communication devices access to a network. A mobile or wireless communication network is one example of a communication network. A communication device may be provided with a service by an application server.

A mobile or wireless communication network may operate in accordance with standard(s), such as those provided by 3GPP (Third Generation Partnership Project) or ETSI (European Telecommunications Standards Institute). Examples of mobile or wireless communication network that operate in accordance with 3GPP standards are generally referred to as 4G (4th Generation) networks, 5G (5th Generation) network, 5G-Advanced networks and 6G networks.

### SUMMARY

Some embodiments of this disclosure will be described with respect to certain aspects. These aspects are not intended to indicate key or essential features of the various example embodiments of this disclosure, nor are they intended to be used to limit the scope of thereof. Other features, aspects, and elements will be readily apparent to a person skilled in the art in view of this disclosure. For example, it should be appreciated that further aspects may be provided by the combination of any two or more of the various aspects described herein.

In a first aspect there is provided a method comprising obtaining at least one predicted pathloss, wherein the pathloss corresponds to at least one target pathloss reference signal, determining whether the at least one target pathloss reference signal is maintained based on at least one first condition, wherein the at least one first condition is associated with the at least one predicted pathloss and based on the determining whether the at least one target pathloss reference signal is maintained, determining a switching delay value.

The method may comprise, if the at least one target pathloss reference signal is maintained, determining at least part of the switching delay value is set to zero.

The method may comprise, if the at least one target pathloss reference signal is not maintained or partially maintained, determining at least part of the switching delay value to be a function of one or more prediction instances.

The method may comprise, if the at least one target pathloss reference signal is not maintained or partially maintained, determining at least part of the switching delay value to be a function of one or more prediction instances of a quality higher than a threshold value.

The at least one first condition may comprise a number of reference signals activated as pathloss reference signals per serving cell or carrier among all active transmission configuration indicator states being less than a threshold value.

At least one of the reference signals activated as pathloss reference signals may be predicted.

The at least one first condition may comprise at least one of: a quality of the at least one target pathloss reference signal, a number of times the at least one predicted pathloss has been predicted for the at least one target pathloss reference signal or the number of times the at least one predicted pathloss has been predicted for the at least one target pathloss reference signal within a time period.

The quality of the at least one target pathloss reference signal may correspond to a prediction confidence value or level or a prediction accuracy level.

The quality of the at least one target pathloss reference signal may be based on at least one of Layer3-Reference Signal Received Power, Layer1 Reference Signal Received Power, signal-to-noise ratio or signal to interference and noise ratio of the target pathloss reference signal.

The at least one first condition may comprise that the quality of the at least one target pathloss reference signal is at least one of above a threshold or above a threshold for at least one time period.

The at least one first condition may comprise a relative difference between the at least one predicted pathloss and a previously determined pathloss being below a threshold or below a threshold for at least one time period.

The at least one first condition may comprise that a pathloss reference signal switch command is received within a time period of a prediction of the at least one predicted pathloss, a time period of reporting a parameter determined based on the at least one predicted pathloss for the at least one target pathloss reference signal or after at least one predicted measurement report corresponding to the at least one target pathloss reference signal being sent.

The at least one first condition may comprise receiving pathloss information from a network entity.

The at least one first condition may comprise receiving a pathloss reference signal switch command within a time period of receiving the pathloss information from the network entity.

The at least one first condition may comprise that the target pathloss reference signal is in a valid subset.

The at least one first condition may comprise that the at least one predicted pathloss or the at least one target pathloss reference signal is within an associated validity period.

The at least one predicted pathloss may correspond to a prediction of pathloss value, or a prediction of at least one component used in the determination of a pathloss value corresponding to the at least one target pathloss reference signal, or a prediction of the at least one target pathloss reference signal

Obtaining the at least one predicted pathloss may comprise determining the at least one predicted pathloss at the apparatus or receiving the at least one predicted pathloss from a network entity.

In a second aspect there is provided an apparatus comprising means for performing the method according to the first aspect.

In a third aspect there is provided an apparatus comprising at least one processor, and at least one memory storing instructions which, when executed by the at least one processor, cause the apparatus at least to perform a method according to the first aspect.

In a fourth aspect there is provided a non-transitory computer readable medium comprising instructions wherein the instructions when executed by at least one processor of an apparatus cause the apparatus to perform the method according to the first aspect.

In a fifth aspect there is provided a computer program comprising instructions which, when executed by an apparatus, cause the apparatus to perform at least the method according to the first aspect.

Some embodiments of the invention are defined in the dependent claims.

In the above, many different aspects have been described. As previously noted, it should be appreciated that further aspects may be provided by the combination of any two or more of the aspects described above (or otherwise in this disclosure).

Various other aspects are also described in the following detailed description and in the claims.

### BRIEF DESCRIPTION OF THE FIGURES

Some embodiments will be described, by way of non-limiting and illustrative example only, with reference to the figures, in which:

FIG. 1 shows an example of a communication network to which examples disclosed herein may be applied;

FIG. 2 shows a flowchart of a method according to an example;

FIG. 3 shows a flowchart of a method according to an example;

FIG. 4 shows a signalling flow between a gNB and a UE;

FIG. 5 shows an example of an apparatus.

### DETAILED DESCRIPTION

The following embodiments are provided by way of non-limiting and illustrative example. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it intended such feature, structure, or characteristic may be applied in connection with other embodiments (whether or not explicitly described).

It shall be understood that although the terms “first,” “second” and the like may be used herein to describe various elements, these elements should not be limited by these terms. These terms are only used to distinguish one element from another.

For the purposes of this disclosure, the phrases “at least one of A or B”, “at least one of A and B”, and “A and/or B” means (A), (B), or (A and B). For the purposes of this disclosure, the phrase “A, B, and/or C” means (A), (B), (C), (A and B), (A and C), (B and C), or (A, B, and C).

As used herein, the term “or” refers to a non-exclusive “or” unless otherwise indicated (e.g., use of “or else” or “or in the alternative”).

As used herein, unless stated explicitly, performing a respective feature, step, or functionality “in response to A” does not indicate that the respective feature, step, or functionality is performed immediately after “A” occurs as one or more intervening features, steps, or functionalities may be performed (at least in part) between an occurrence of the respective feature, step, or function and “A”. Analogously, performing a respective feature, step, or functionality “based on A” does not indicate that the respective feature, step, or functionality is performed solely based on “A” as the respective feature, step, or functionality may be further based on one or more other features, steps, or functionalities in addition to “A”.

Embodiments described herein may be implemented in a communication network, such as any of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future RAT such as 6G. Moreover, communication within the communication network may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), and/or Discrete Fourier Transform spread OFDM (DFT-s-OFDM).

As used herein, the term “network device” or “network node” refers to a node in a communication network via which user equipment may access the network and/or which is configured to control radio communication and managing radio resources within a cell. The network node or network device may be referred to as a base station (BS), an access point (AP) or an access node. The network device may be, depending on the applied technology, for example, a node B (NodeB or NB), an evolved NodeB (eNodeB or eNB), an NR NB (also referred to as a gNB), a Remote Radio Unit (RRU), a radio head (RH), a remote radio head (RRH), a relay, an Integrated Access and Backhaul (IAB) node, a low power node, a non-terrestrial network (NTN) or non-ground network device, such as a satellite network device, a low earth orbit (LEO) satellite and a geosynchronous earth orbit (GEO) satellite, or an aircraft network device.

Moreover, in connection of split radio access network (RAN), the network device may refer to a centralised unit (CU) of a base station and/or a distributed unit (DU) of a base station. An interface between CU and DU may be referred to as an F1 interface in NR. In the split RAN architecture, node operations may be carried out, at least partly, in the central/centralized unit, CU, (e.g. server, host or node) operationally coupled to the DU, (e.g. a radio head/node). One CU may control one or more DUs, acting at least as transmit/receive (Tx/Rx) nodes. In some embodiments, the DUs may comprise e.g. a radio link control (RLC), medium access control (MAC) layer and a physical (PHY) layer, whereas the CU may comprise the layers above RLC layer, such as a packet data convergence protocol (PDCP) layer, a radio resource control (RRC) and an internet protocol (IP) layers. Other functional splits are possible too. In practice, any processing task may be performed in either the CU or the DU and the boundary where the responsibility is shifted between the CU and the DU may depend on the applied implementation.

The term “terminal device” refers to any end device that may be configured to perform wireless communication. By way of example, a terminal device may be referred to as a communication device, user equipment (UE), a Subscriber Station (SS), or a Mobile Station (MS). The terminal device may include a mobile phone, a cellular phone, a smart phone, voice over IP (VOIP) phones, wireless local loop phones a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

A term “resource”, as used herein, may refer to radio resources in time domain, in frequency domain, in space domain, and/or in code domain. Some examples of resources may include, e.g., a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources.

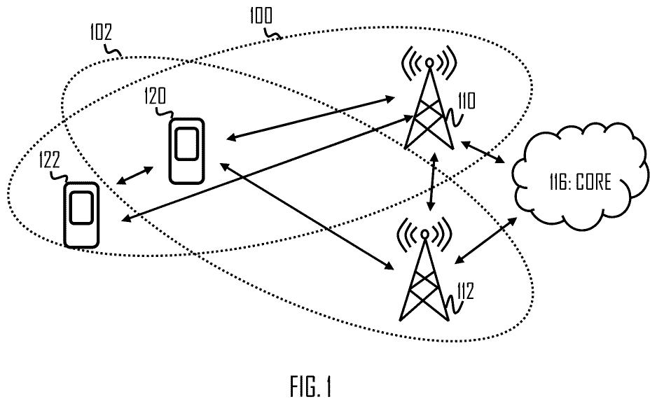

FIG. 1 illustrates an example of a communication network to which examples disclosed herein may be applied. The communication network or a cellular communication network may comprise a network node 110 configured to provide one or more cells, such as cell 100, and a network node 112 configured to provide one or more other cells, such as cell 102. Each cell may, for example, be a macro cell, a micro cell, femto, or a pico cell. The cell may define a coverage area or a service area of the corresponding access node.

The network node (110, 112) may be configured to provide a user equipment (UE) 120 (one or more UEs) with wireless access to the communication network. The wireless access may comprise downlink (DL) communication from the network node (110, 112) to the UE 120 and uplink (UL) communication from the UE 120 to the network node (110, 112). Examples of uplink channels may comprise physical uplink control channel (PUCCH) for transmitting control information and physical uplink shared channel (PUSCH) for transmitting data towards the network. Examples of downlink channels may comprise physical downlink control channel (PDCCH) for transmitting control information and physical downlink shared channel (PDSCH) for transmitting data towards the user equipment.

There may be a plurality of UEs (120, 122) in the system. Each of the plurality of UEs may be served by the same or by different network nodes (110, 112). UE may be configured with dual connectivity (DC), wherein the UE, for example UE 120, may be connected to multiple network nodes (110, 112). The UEs (120, 122) may communicate with each other, in case device-to-device (D2D) communication interface is established between them via a so-called sidelink (SL). Such D2D communications may be referred to as machine-to-machine, peer-to-peer (P2P) communications, or vehicle-to-vehicle (V2V), for example.

In the case of multiple network nodes in the communication network, the network nodes may be connected to each other via an interface. LTE specifications, for example, refer to such an interface as an X2 interface. An interface between an LTE node and a 5G node, or between two 5G nodes may be called an Xn interface.

The network nodes 110 and 112 may be further connected via another interface to a core network 116 of the communication network. The LTE specifications specify the core network as an evolved packet core (EPC), and the core network may comprise a plurality of entities (e.g. a mobility management entity (MME) and a gateway node). The MME may handle mobility of terminal devices in a tracking area encompassing a plurality of cells and handle signalling connections between the terminal devices and the core network. The gateway node may handle data routing in the core network and to/from the terminal devices. The 5G specifications specify the core network as a 5G core (5GC). The 5GC may, for example, comprise an access and mobility management function (AMF) and a user plane function/gateway (UPF) and other functions. The AMF may handle termination of non-access stratum (NAS) signalling, NAS ciphering & integrity protection, registration management, connection management, mobility management, access authentication and authorization, security context management. The UPF node may, for example, support packet routing and forwarding, packet inspection and quality of service (QoS) handling.

NR PUSCH power control is essentially based on a combination of open-loop power control, including support for fractional path-loss compensation, where the UE estimates the UL path-loss based on DL measurements and sets the transmit power accordingly and closed-loop power control based on explicit transmit power-control (TPC) commands provided by the network.

In NR, a UE determines the PUSCH transmission power based on the procedures described in Sec. 7.1 of TS 38.213. In summary, the UE is indicated and/or determines closed-loop parameters (e.g., closed-loop index, TPC command) and open-loop parameters (e.g., pathloss reference signal, p0, alpha). The TPC command is carried in the DCI scheduling the PUSCH transmission. The TPC command (and corresponding closed-loop index) may be carried jointly to multiple UEs by means of group-common DCI using DCI format 2-2.

Some of the main power control parameters on which the PUSCH transmission power depends include but are not limited to closed-loop index (also known as PC adjustment state), TPC command (f_{b,f,c}, absolute or accumulative TPC command), pathloss RS (reference signal), p (also denoted as P_{0_UE_PUSCH}), alpha (for partial or full path-loss compensation), DELTA_TF (i.e., Δ_{TF,b,f,c}(i)), also sometimes referred to as power adjustment component related to Modulation and Coding Scheme (MCS).

If UE transmits a PUSCH on active UL BWP b of carrier f of serving cell c using parameter set configuration with index j and PUSCH power control adjustment state with index l, the UE may determine the PUSCH transmission power P_{PUSCH,b,f,c}(i, j, q_{d}, l) in PUSCH transmission occasion i as

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] .$$

Sounding Reference Signal (SRS) power control is similar to PUSCH power control. SRS transmission power may be based on the following. If a UE transmits SRS based on a configuration by SRS-ResourceSet on active UL BWP b of carrier f of serving cell c using SRS power control adjustment state with index l, the UE determines the SRS transmission power P_{SRS,b,f,c}(i, qₛ, l) in SRS transmission occasion i as

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ] .$$

PUCCH transmission power may be determined based on the following. If a UE transmits a PUCCH on active UL bandwidth part (BWP) b of carrier f in the primary cell c using PUCCH power control adjustment state with index l, the UE determines the PUCCH transmission power P_{PUCCH,b,f,c} (i, qᵤ, q_{d}, l) in PUCCH transmission occasion i as

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix}\end{matrix} \} [ dBm ] .$$

PL refers to the pathloss component/parameter, which may be determined per beam by downlink reference signal either from Synchronization Signal Block (SSB) or Channel State Information Reference Signal (CSI-RS), and is defined as follows: PL_{b,f,c}(q_{d})=referenceSignalPower−higher layer filtered Reference Singla Received Power (RSRP), where referenceSignalPower is provided by higher layers and RSRP for the reference serving cell and the higher layer filter configuration. A UE is not expected to simultaneously maintain more than four pathloss estimates per serving cell for all PUSCH/PUCCH/SRS transmissions.

Rel-17 introduce a unified TCI (transmission configuration indicator) framework meaning that TCI states providing Quasi Co-Location (QCL) assumptions for the reception of DL signals and channels would be used also to provide spatial sources for the transmission of UL signals and channels.

The Rel-17 unified TCI framework comprises the following functionalities in high level. RRC configures set (or pool) of joint and/or separate TCI states. MAC activates a number (e.g. 8) of joint and/or separate TCI states Before a first indication, first activated TCI state is the current indicated TCI state. DCI indicates one of the activated TCI states to be the indicated TCI state (which may be a common TCI state). The TCI (transmission configuration indicator) state may comprise or be associated with pathloss reference signal.

Switching delay requirements may be defined based on a pathloss reference signal being e.g., known or not known. For a pathloss reference signal to be considered as known there are set of conditions defined which are primarily centered around DL measurements corresponding to this reference signal and around reference signal being transmitted by the network.

Requirements for a UE to update a pathloss reference signal by MAC Control Element (MAC-CE) for PUCCH, PUSCH, semi-persistent SRS and aperiodic SRS may be as follows.

If the target pathloss reference signal is known, upon receiving PDSCH carrying MAC-CE activation in slot n, UE shall be able to apply the target pathloss reference signal of the serving cell on which pathloss reference signal switch occurs no later than the slot

$$n + {T}_{HARQ} + 3 {N}_{slot}^{subframe , μ} + NM * ⌈ \frac{5 * {T}_{target \_ PL - RS} + 2 ms}{NR slot length} ⌉ \cdot$$

The UE shall be able to apply old pathloss reference signals until the slot

$$n + {T}_{HARQ} + 3 {N}_{slot}^{subframe , μ} .$$

Where T_{HARQ} is the timing between pathloss reference MAC-CE activation command and acknowledgement as specified in TS 38.321 [7] and NM=1, if the target PL-RS is not maintained by the UE, 0 otherwise.

In FR2, if the target pathloss reference signal is SSB, the requirements in this clause shall apply when the target pathloss reference signal (PL-RS) is maintained by the UE. T_{target_PL-RS} is the periodicity of the target pathloss reference signal which would be SSB or NZP CSI-RS. PL-RS is maintained provided there are no more than 4 different RS activated as PL-RS per serving cell among all active spatial relations for PUSCH/PUCCH/SRS transmissions, the target pathloss reference signal remains detectable during TCI state switching period (e.g., Signal to Noise Ratio (SNR) of the target pathloss reference signal≥−3 dB) and the associated SSBs with the target pathloss reference signal remain detectable during the TCI state switching period (e.g., SNR of the associated SSB≥−3 dB)

A longer application time is expected if measurement sample is not available due to measurement gap, Discontinuous Reception (DRX) or other UE activities and/or if the pathloss reference signal is unknown.

There are an increasing number of use cases where less reference signal (RS) measurements would be available at the UE, be it in time domain and/or spatial domain. For overhead reduction, e.g., through beam (ID) prediction, less beams/RSs (in time or space or both) would be transmitted and thus measured. For energy savings RSs/beams may be less frequently transmitted and thus measured and/or a reduced number of RSs/beams may be transmitted and measured.

For more accurate prediction, pathloss is calculated by filtering RSRP measurements using an exponential filter. AI/ML may filter measurements much better and model any potential trend in PL changes. Considering narrower beams in some cases, without necessarily increasing the overhead and burden in the system.

Hence, there is room to leverage Artificial Intelligence/Machine Learning (AI-ML) and enable pathloss prediction

A pathloss prediction framework can be enabled and incorporated to UL power control operation. Different options can be considered in that regard, such as enabling pathloss prediction built on top of the Rel-19 beam prediction framework although enabling pathloss prediction doesn't necessarily need to be tied to the Rel-19 beam prediction framework.

A UE-sided AI-ML model for PL prediction is an option while a NW-sided AI-ML model is also a possibility.

In the case of pathloss prediction, a reference signal may not be transmitted or may not be measured, or may be less frequently transmitted/measured. Hence, most of the existing conditions and requirements cannot be used in this case. Without defining suitable applicability conditions for pathloss reference signal switching delay requirements specific to scenarios where pathloss prediction is applied or used, it may not be possible to define reasonable pathloss reference signal switch delay requirements.

The following addresses how to define requirements and applicability conditions for pathloss reference signal switching considering that pathloss prediction is used.

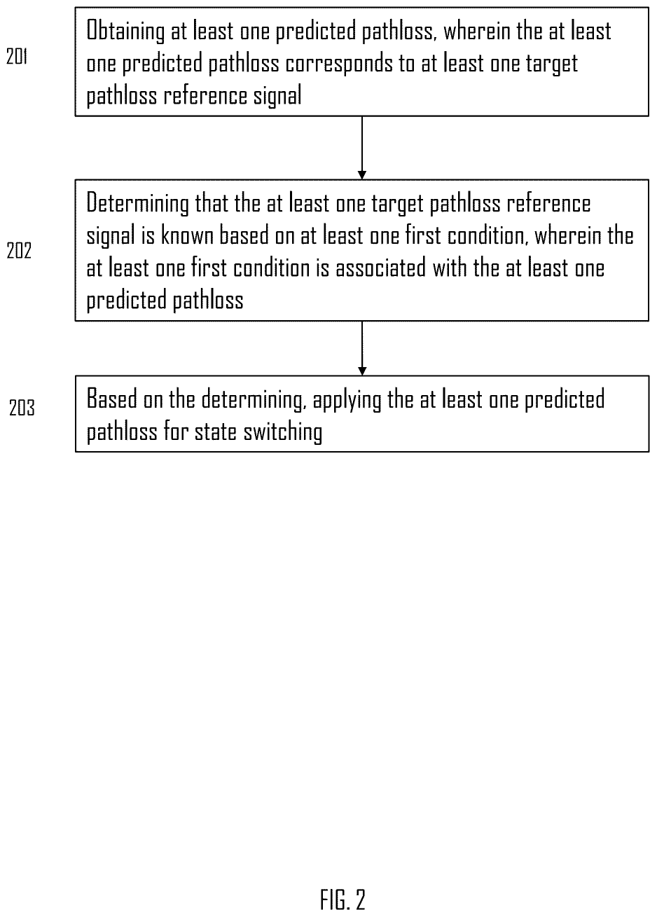

FIG. 2 shows a flowchart of a method according to an example embodiment. The method may be performed at an apparatus. The apparatus may be, comprise or be comprised in a UE.

At 201, the method comprises obtaining at least one predicted pathloss, wherein the at least one predicted pathloss corresponds to at least one target pathloss reference signal.

At 202, the method comprises determining that the at least one target pathloss reference signal is known based on at least one first condition, wherein the at least one first condition is associated with the at least one predicted pathloss.

At 203, the method comprises, based on the determining, applying the at least one predicted pathloss for state switching.

The method may provide applicability conditions for a target pathloss reference signal in case of pathloss prediction(s), where such conditions are at least partially based on corresponding pathloss prediction.

In an example, for a UE configured or indicated to perform pathloss prediction corresponding to at least one reference signal, the UE considers or determines that a target pathloss reference signal (also referred to as a path loss reference signal or PL-RS) is known if at least one first condition is valid or satisfied:

The at least one first condition may comprise that a quality of the at least one target pathloss reference signal. The at least one first condition may comprise that the quality of the at least one target pathloss reference signal is at least one of above a threshold or above a threshold for at least one time period.

The quality of the at least one target pathloss reference signal may be based on at least one of Layer3-Reference Signal Received Power, Layer1 Reference Signal Received Power, signal-to-noise ratio (SNR) or signal to interference and noise ratio (SINR) of the target pathloss reference signal. Alternatively, or in addition, the quality of the at least one target pathloss reference signal may correspond to a prediction confidence value or level or a prediction accuracy level.

The levels, values, thresholds and/or at least one time period may be predetermined, configured (e.g., via RRC), fixed in specifications and/or up to UE capability.

For example, if the quality of the target pathloss reference signal is above a certain level (i.e. threshold), wherein the quality may correspond to, but is not limited to, L3 RSRP, L1-RSRP, SNR, or SINR, the target pathloss signal is considered to be known. The quality may be at least partially based on pathloss prediction. Alternatively, or in addition, the quality may be at least partially based on, correspond to or account for prediction accuracy or prediction confidence level. Such quality may need to be maintained for at least a time period.

Alternatively, or in addition, the at least one first condition may comprise a relative difference between the at least one predicted pathloss and a previously determined at least one pathloss being at least one of below a threshold or below a threshold for at least one time period.

For example, if a relative difference between PL prediction for the target PL-RS and a pre-determined PL (e.g., based on one or more previous (measured) PL) is within level(s), the target pathloss reference signal may be considered to be known. The levels may be predetermined, configured (e.g., via RRC), fixed in specifications and/or up to UE capability.

Alternatively, or in addition, the at least one first condition may comprise a number of times the at least one predicted pathloss has been predicted for the at least one target pathloss reference signal, or the number of times the at least one predicted pathloss has been predicted for the at least one target pathloss reference signal within at least one time period.

For example, pathloss prediction for the target pathloss reference signal may be done at least one or a number of times. The at least one first condition may comprise a number. Such a number may be configured (e.g., via RRC) or fixed in specifications and/or up to UE capability. Alternatively, or additionally, the at least one first condition may comprise that the number of pathloss predictions is done within at least one time period (e.g., a time window or within a time offset (e.g., from an UL transmission associated with the pathloss reference signal)). Such a time period (e.g., time window or time offset) may be configured (e.g., via RRC) or fixed in specifications and/or up to UE capability.

Additionally, or alternatively, the at least one first condition may comprise that a pathloss reference signal switch command is received within a time period of a prediction of the at least one predicted pathloss or within a time period of reporting a parameter determined based on the at least one predicted pathloss for the at least one target pathloss reference signal. The parameter may be RSRP or pathloss determined at least partially based on a prediction corresponding to the target pathloss reference signal.

For example, if a pathloss reference signal switch command is received within at least one time period (e.g., time offset, or time window), upon the last prediction of the pathloss reference signal or upon reporting RSRP/pathloss determined at least partially based on a prediction corresponding to the target pathloss reference signal, the target pathloss reference signal may be considered to be known.

Alternatively, or in addition, the at least one first condition may comprise that at least one predicted measurement report corresponding to the at least one target pathloss reference signal has been sent.

For example, if the UE has sent at least one (or a number of) measurement prediction report for, or corresponding to, the target pathloss reference signal before the pathloss reference signal switch command, the target pathloss reference signal may be considered to be known.

Additionally, or alternatively, the at least one first condition may comprise receiving pathloss information from a network entity. The pathloss information may be a pathloss indication or pathloss information indication.

For example, the UE considers or determines that a pathloss reference signal is known if the UE receives pathloss indication, or pathloss information indication, from the network.

The at least one first condition may comprise receiving a pathloss reference signal switch command within a time period (e.g., a time offset or time window) of receiving pathloss information from the network entity. For example, if a pathloss reference signal switch command is received within a time offset, or a time window, upon receiving pathloss indication, or pathloss information indication, from the network, the target pathloss reference signal is considered to be known.

Additionally, or alternatively, the at least one first condition may comprise that the at least one target pathloss reference signal is in a valid subset.

For example, the UE considers or determines that a target pathloss reference signal is known if the target PL-RS for the corresponding slot is comprised in a valid (e.g., pre-determined/pre-configured) subset for PL-RS. A valid PL-RS may be in terms of allowing pathloss prediction corresponding to this PL-RS and/or in terms of output of the pathloss prediction (i.e., valid prediction). The subset of valid PL-RS may be configured by NW and/or determined/indicated by UE (e.g., relatively to the last target PL-RS or active PL-RS, etc.). The subset size of valid PL-RS may be smaller (or greater) or equal to the number of different RS activated as PL-RS per serving cell among all active spatial relations or TCI states for PUSCH/PUCCH/SRS transmissions

Alternatively, or in addition, the at least one condition may comprise that the at least one predicted pathloss or the at least one target pathloss reference signal is within an associated validity period.

If the predicted PL and/or target PL-RS is within its validity period (which may be a time window or timer). The validity period may start upon a time offset (>=0) relative to the last prediction of the pathloss reference signal or PL value, or upon reporting RSRP/pathloss determined at least partially based on prediction corresponding to the pathloss reference signal. The validity period may end no longer than a pre-defined period configured by NW or UE capability or specified in the specs. The validity period may also end earlier than the pre-defined period based on specific conditions (e.g., NW indication, UE determined cases).

If one or more of the at least one first conditions described above are not satisfied, the target pathloss reference signal is assumed or considered as not known or unknown.

If the target pathloss reference signal is known, a faster and/or shorter pathloss reference signal switching or usage or validity requirements apply, so UL transmission(s) (such as PUSCH, PUCCH, SRS, PRACH) corresponding to a TCI state associated with target pathloss reference signal can start sooner when compared to the unknown case.

The state switching may comprise pathloss reference signal switching or TCI state switching. applying the at least one predicted pathloss for state switching may comprise applying a reduced state switching delay, usage or validity requirements.

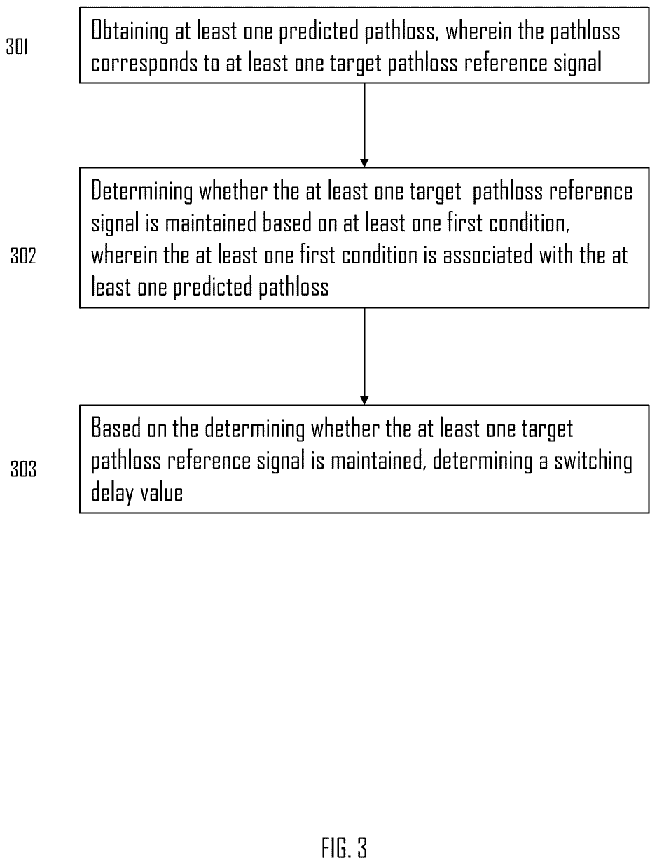

FIG. 3 shows a flowchart of a method according to an example embodiment. The method may be performed at an apparatus. The apparatus may be, comprise or be comprised in a UE.

At 301, the method comprises obtaining at least one predicted pathloss, wherein the pathloss corresponds to at least one target pathloss reference signal.

At 302, the method comprises determining whether the at least one target pathloss reference signal is maintained based on at least one first condition, wherein the at least one first condition is associated with the at least one predicted pathloss.

At 303, based on the determining whether the at least one target pathloss reference signal is maintained, determining a switching delay value.

The at least one condition may comprise any of the at least one first conditions described above.

Additionally, or alternatively, the at least one first condition may comprise: a number of reference signals activated as pathloss reference signals per serving cell or carrier among all active transmission configuration indicator states being less than a threshold value. At least one of the reference signals activated as pathloss reference signals may be predicted.

In an example, the UE considers or determines that a pathloss reference signal is maintained if there are no more than a number of reference signals activated as pathloss reference signal per serving cell among all active TCI states for UL transmissions, where pathloss of some of these reference signals may be predicted. Such a number may be configured (e.g., via RRC) or fixed in specifications or up to UE capability.

If the at least one target pathloss reference signal is maintained, a method as described with reference to FIG. 3 may comprise determining at least part of the switching delay value is set to zero.

For example, if the target pathloss reference signal is determined to be maintained based on the at least one first condition, then at least some parts of the switching or update delay may be set to a predefined value (which may be 0 or different from 0). Such a delay corresponds to the earliest time the target pathloss reference signal can be applied by the UE.

In an example, if the pathloss reference signal is determined to be maintained based on the at least one first condition, there is no switching delta, i.e., the pathloss reference signal and/or associated pathloss value(s) can be used (e.g., in association with an UL transmission).

If the at least one target pathloss reference signal is not maintained or partially maintained, the method as described with reference to FIG. 3 may comprise determining at least part of the switching delay value to be a function of one or more prediction instances.

For example, pathloss reference signal switch delay may be a function of at least a number (1 or greater than 1) of prediction instances corresponding to the pathloss reference signal. Such a number may be configured (e.g., via RRC) or fixed in specifications or up to UE capability. This may be applicable if the pathloss reference signal is not maintained or is partially maintained.

If the at least one target pathloss reference signal is not maintained or partially maintained, the method as described with reference to FIG. 3 may comprise determining at least part of the switching delay value to be a function of one or more prediction instances of a quality higher than a threshold value.

For example, pathloss reference signal switch delay may be a function of at least a number (1 or greater than 1) of prediction instances, corresponding to the pathloss reference signal, which are of a quality higher than a threshold. Such a number may be configured (e.g., via RRC) or fixed in specifications or up to UE capability. This may be applicable if the pathloss reference signal is not maintained or is partially maintained.

The predicted pathloss corresponding to at least one target pathloss reference signal described with reference to FIGS. 2 to 3 may correspond to a prediction of pathloss value (e.g., as a function of RSRP), or a prediction of at least one component (such as L1-RSRP) used in the determination/calculation of a pathloss value corresponding to the at least one target pathloss reference signal, or a prediction of the at least one target pathloss reference signal.

Obtaining the at least one predicted pathloss may comprise at least one of: determining the at least one predicted pathloss at the apparatus or receiving the at least one predicted pathloss from a network entity.

The prediction may be based on AI/ML (artificial intelligence/machine learning) or any other algorithm suitable for prediction.

The pathloss prediction may be done (i.e. performed or determined) at the UE side (e.g., AI-ML model at the UE side), however other options are possible such as network-sided pathloss prediction (e.g., AI-ML model at the network side) or pathloss prediction done jointly at the UE side and network side.

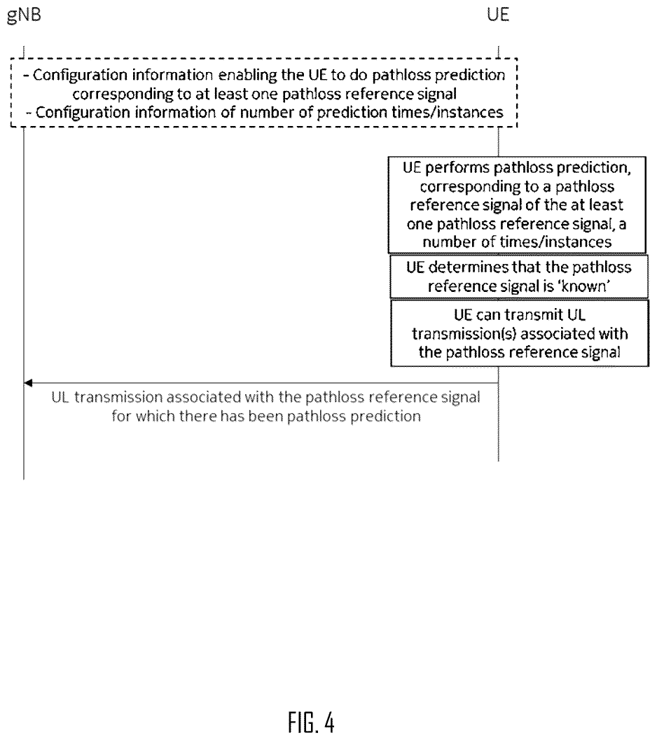

FIG. 4 shows a signalling flow between a gNB and a UE for an example method. In this example, the at least one first condition comprises a number of times the at least one predicted pathloss has been predicted for the at least one target pathloss reference signal. In this example, the gNB provides configuration information enabling the UE to perform pathloss prediction corresponding to at least one pathloss reference signal and configuration information of a number of prediction times/instances (i.e. for pathloss prediction). The UE then performs pathloss prediction corresponding to a pathloss reference signal of the at least one pathloss reference signal a number of times/instances as configured. This is an example of obtaining at least one predicted pathloss, wherein the at least one predicted pathloss corresponds to at least one target pathloss reference signal. In this example, the UE determines that the pathloss reference signal is known and can transmit UL transmission(s) associated with the pathloss reference signal. This is an example of determining that the at least one target pathloss reference signal is known based on at least one first condition. The UE then makes a transmission associated with the pathloss reference signal for which there has been pathloss prediction.

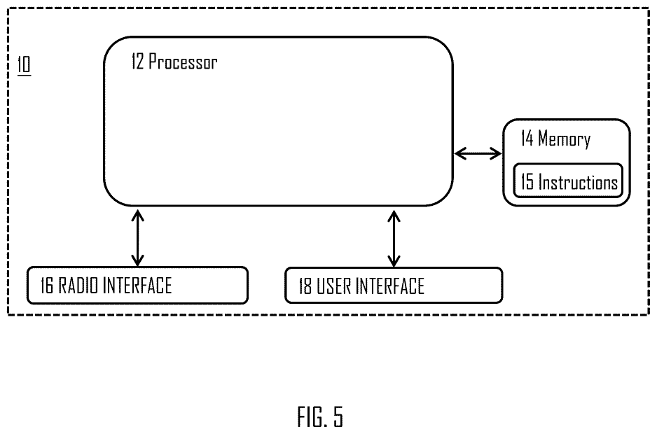

FIG. 5 shows, by way of example, a block diagram of an apparatus 10. The apparatus 10 comprises, for example, at least one processor 12 and at least one memory 14 storing instructions 15 that, when executed by the at least one processor, cause the apparatus 10 at least to perform the method or methods (or portion(s) thereof) as disclosed herein, and any of the embodiments (or respective portion(s) thereof). In an example, the at least one memory and the instructions (e.g. a computer program code, software), are configured, with the at least one processor, to cause the apparatus 10 to perform the method or methods (or portion(s) thereof) as disclosed herein, and any of the embodiments (or respective portion(s) thereof).

A processor 12 may comprise circuitry, or be constituted as circuitry or circuitries, the circuitry or circuitries being configured to perform phases of methods in accordance with embodiments described herein.

As used herein, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 14 may be implemented using any suitable data storage technology. The memory may comprise a database for storing data. The memory 14 may, for example, be at least in part external to apparatus 10 but accessible to apparatus 10.

The instructions 15 may be comprised in a computer readable medium or a non-transitory computer readable medium. A term non-transitory, as used herein, is a limitation of the medium itself (i.e. tangible, not a signal) as opposed to a limitation on data storage persistency (e.g. random access memory, RAM, vs. read only memory, ROM).

For example, the apparatus 10 is a terminal device, such as a UE. As another example, the apparatus is comprised in such a terminal device, e.g. as a chipset configured to control the terminal device. The apparatus 10 may be caused or configured or comprise means to perform at least the method of FIGS. 2 and 3 and/or any one or more of the embodiments described herein.

The apparatus 10 comprises a radio interface 16. The radio interface 16 may provide the apparatus 10 with communication capabilities. The radio interface 16 may comprise a receiver configured to receive information in accordance with at least one cellular or non-cellular standard. The radio interface 16 may comprise a transmitter configured to transmit information in accordance with at least one cellular or non-cellular standard. The receiver may comprise more than one receiver. The transmitter may comprise more than one transmitter. The radio interface 16 may comprise a transceiver configured to receive and transmit information in accordance with at least one cellular or non-cellular standard. The transceiver may comprise more than one transceiver.

The apparatus 10 may comprise a user interface 18 comprising, for example, at least one of a keypad, a microphone, a touch display, a display, a speaker, etc. The user interface 18 may be used to control the apparatus by the user. The user interface 18 may be external to the apparatus 10. For example, the apparatus 10 may be connected to another device, such as a computer, either via wireless or wired connection, and the apparatus 10 is controlled by the user via the computer.

In an embodiment, at least some of the processes described herein may be carried out by an apparatus comprising means for carrying out at least some of the described processes. Means for performing method steps as disclosed herein may include software and/or hardware components of the apparatus 10. For example, the at least one processor 12, the memory 14, and the computer program code form means for carrying out the method or methods (or portion(s) thereof) as disclosed herein, and any of the embodiments (or respective portion(s) thereof). As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Even though this disclosure has been described above with reference to non-limiting and illustrative examples according to the accompanying figures, it is clear that the scope of this disclosure is not restricted thereto—but can be modified in many different ways. As technology advances, it will become apparent to a person skilled in art as to how the disclosure can be further implemented and/or modified in various ways. Further, it is clear to a person skilled in the art that the embodiments described herein may, but are not required to, be combined in various ways with other embodiments described herein.

1. An apparatus comprising at least one processor, and at least one memory storing instructions which, when executed by the at least one processor, cause the apparatus to at least:
obtain at least one predicted pathloss, wherein the pathloss corresponds to at least one target pathloss reference signal;
determine whether the at least one target pathloss reference signal is maintained based on at least one first condition, wherein the at least one first condition is associated with the at least one predicted pathloss; and
based on the determining whether the at least one target pathloss reference signal is maintained, determine a switching delay value.

2. The apparatus according to claim 1, wherein the at least one processor, and the at least one memory storing instructions which, when executed by the at least one processor, further cause the apparatus to at least:
if the at least one target pathloss reference signal is maintained, determine at least part of the switching delay value is set to zero.

3. The apparatus according to claim 1, wherein the at least one processor, and the at least one memory storing instructions which, when executed by the at least one processor, further cause the apparatus to at least:
if the at least one target pathloss reference signal is not maintained or partially maintained, determine at least part of the switching delay value to be a function of one or more prediction instances.

4. The apparatus according to claim 3, wherein the at least one processor, and the at least one memory storing instructions which, when executed by the at least one processor, further cause the apparatus to at least:
if the at least one target pathloss reference signal is not maintained or partially maintained, determine at least part of the switching delay value to be a function of one or more prediction instances of a quality higher than a threshold value.

5. The apparatus according to claim 1, wherein the at least one first condition comprises: a number of reference signals activated as pathloss reference signals per serving cell or carrier among all active transmission configuration indicator states being less than a threshold value.

6. The apparatus according to claim 5, wherein at least one of the reference signals activated as pathloss reference signals is predicted.

7. The apparatus according to claim 1, wherein the at least one first condition comprises at least one of: a quality of the at least one target pathloss reference signal, a number of times the at least one predicted pathloss has been predicted for the at least one target pathloss reference signal or the number of times the at least one predicted pathloss has been predicted for the at least one target pathloss reference signal within a time period.

8. The apparatus according to claim 7, where the quality of the at least one target pathloss reference signal corresponds to a prediction confidence value or level or a prediction accuracy level.

9. The apparatus according to claim 7, wherein the quality of the at least one target pathloss reference signal is based on at least one of Layer3-Reference Signal Received Power, Layer1 Reference Signal Received Power, signal-to-noise ratio or signal to interference and noise ratio of the target pathloss reference signal.

10. The apparatus according to claim 7, wherein the at least one first condition comprises that the quality of the at least one target pathloss reference signal is at least one of above a threshold or above a threshold for at least one time period.

11. The apparatus according to claim 7, wherein the at least one first condition comprises a relative difference between the at least one predicted pathloss and a previously determined pathloss being below a threshold or below a threshold for at least one time period.

12. The apparatus according to claim 1, wherein the at least one first condition comprises that a pathloss reference signal switch command is received within a time period of a prediction of the at least one predicted pathloss, a time period of reporting a parameter determined based on the at least one predicted pathloss for the at least one target pathloss reference signal or after at least one predicted measurement report corresponding to the at least one target pathloss reference signal being sent.

13. The apparatus according to claim 1, wherein the at least one first condition comprises receiving pathloss information from a network entity.

14. The apparatus according to claim 13, wherein the at least one first condition comprises receiving a pathloss reference signal switch command within a time period of receiving the pathloss information from the network entity.

15. The apparatus according to claim 1, wherein the at least one first condition comprises that the target pathloss reference signal is in a valid subset.

16. The apparatus according to claim 1, wherein the at least one first condition comprises that the at least one predicted pathloss or the at least one target pathloss reference signal is within an associated validity period.

17. The apparatus according to claim 1, wherein the at least one predicted pathloss corresponds to a prediction of pathloss value, or a prediction of at least one component used in the determination of a pathloss value corresponding to the at least one target pathloss reference signal, or a prediction of the at least one target pathloss reference signal.

18. The apparatus according to claim 1, wherein obtaining the at least one predicted pathloss comprises determining the at least one predicted pathloss at the apparatus or receiving the at least one predicted pathloss from a network entity.

19. A method comprising:
obtaining at least one predicted pathloss, wherein the pathloss corresponds to at least one target pathloss reference signal;
determining whether the at least one target pathloss reference signal is maintained based on at least one first condition, wherein the at least one first condition is associated with the at least one predicted pathloss; and
based on the determining whether the at least one target pathloss reference signal is maintained, determining a switching delay value.

20. A non-transitory computer program product comprising instructions which, when executed by an apparatus, cause the apparatus to perform at least:
obtain at least one predicted pathloss, wherein the pathloss corresponds to at least one target pathloss reference signal;
determine whether the at least one target pathloss reference signal is maintained based on at least one first condition, wherein the at least one first condition is associated with the at least one predicted pathloss; and
based on the determining whether the at least one target pathloss reference signal is maintained, determine a switching delay value.
